(19) United States
(12) Patent Application Publication
(10) Pub. No.: US 2009/0304936 A1
(43) Pub. Date: Dec. 10, 2009

(54) Protective Coating Application System

(75) Inventor: Yoshiyuki Nakazawa, Saitama (JP)

Correspondence Address: CARRIER BLACKMAN AND ASSOCIATES, 43440 WEST TEN MILE ROAD, EATON CENTER, NOVI, MI, 48375, US

(73) Assignee: Honda Motor Co., Ltd., Minato-ku, Tokyo (JP)

(21) Appl. No.: 11/921,543

(22) PCT Filed: May 26, 2006
(86) PCT No.: PCT/JP2006/311046

§ 371 Date: Jan. 27, 2009

(30) Foreign Application Priority Data
Jun. 2, 2005 (JP) 2005-162553

(51) Int. Cl. B05D 1/42; B05C 11/06

(52) U.S. Cl. 427/348; 118/63

(57) ABSTRACT

A method for applying a protective coating to a painted workpiece uses an application apparatus which discharges the protective coating as well as streams of compressed air for spreading the discharged protective coating on a surface of the workpiece. The protective coating is fed from an application nozzle unit to the workpiece. The protective coating is uniformly spread over the workpiece by streams of compressed air radiated thereat.

### TECHNICAL FIELD

The present invention relates to a method for applying a protective coating to a paint film for protection, and an application nozzle unit suitable for use in the method.

### BACKGROUND ART

Vehicular bodies such as automotive bodies are painted to provide not only improved appearances but also improved resistance to rust. The vehicle bodies would provide less commercial values if paint films formed on the bodies are damaged. To protect these paint films against damage, the paint films are coated with coatings. Such coatings are called “protective coatings”.

The protective coatings need to be evenly applied and spread to provide a uniform thickness, as in the case of painting of the vehicle bodies. Such even application of the protective coatings is achieved using a nozzle unit disclosed in JP-B-3498941.

The disclosed nozzle unit will be discussed with reference to FIG. 12. As shown in FIG. 12, the nozzle unit denoted by reference numeral 100 includes a nozzle body 101, a plate member 102, and a plurality of bolts 103 connecting the plate member 102 to the nozzle body 101. The plate member 102 has a horizontal groove 105 for receiving a protective coating fed from a feed port 104 formed in the nozzle body 101. The plate member 102 has a plurality of discharge passages 106 through which the protective coating flows out.

Description will be made as to application of the protective coating, fed from the nozzle unit 100, to a workpiece 110, with reference to FIG. 13.

As shown in FIG. 13, the protective coating, designated at 111, is fed from the nozzle unit 100 to the workpiece 110. Next, a roller 112 presses the protective coating 111 for spreading the coating 111 over the workpiece 110 to provide a protective film 113 on the workpiece 110.

The roller 112 is rotatably supported by levers 115 through pins 114. More specifically, opposite ends of the roller 112 are supported by the levers 115, 115. When the roller 112 is subjected to a reaction force from the workpiece 110, a roller center located furthest from the pins 114 flexes away from the workpiece 110. As a result, the protective film 113 is not rendered uniform in thickness.

Additionally, using the roller 112 for a long time inevitably leaves linear flaws on a surface of the roller 112. These linear flaws of the roller 112 leave a linear pattern on the protective film 113. This results in unpleasant outer appearance of the protective film 113.

There is a demand for an alternative to the above application method using the roller 113.

### DISCLOSURE OF THE INVENTION

According to one aspect of the present invention, there is provided a method for applying a protective coating to a painted workpiece, which method comprises the steps of: feeding the protective coating from an application nozzle unit to the workpiece; and applying streams of compressed air onto the fed protective coating to thereby uniformly spread the protective coating.

Because the compressed air is used for spreading the protective coating over the workpiece, the spread protective coating has no mark which would be otherwise left thereon if a roller, a bristle or the like were used. Thus, the protective coating has its clean surface.

Desirably, the applying step comprises jetting the streams of compressed air from jet ports defined in the application nozzle unit.

Preferably, the applying step comprises jetting the streams of compressed air from one of a pair of jet ports defined in the application nozzle unit.

In a preferred form, the feeding step comprises discharging the protective coating from a plurality of discharge ports defined in the application nozzle unit.

In a further preferred form, the feeding step comprises discharging the protective coating from a plurality of discharge ports defined in the application nozzle unit while moving the nozzle unit to and fro, and wherein the applying step comprises jetting the streams of compressed air from a front jet port defined in the application nozzle unit and located forwardly of the discharge ports during rearward movement of the application nozzle unit, and jetting the streams of compressed air from a rear jet port defined in the application nozzle unit and located rearwardly of the discharge ports during forward movement of the application nozzle unit.

According to a second aspect of the present invention, there is provided an applying apparatus for applying a protective coating to a painted workpiece, the apparatus comprising: a movable application nozzle unit; a directional control valve; the application nozzle unit including: a block having a coating reservoir defined therein for holding the protective coating; a nozzle plate having a plurality of discharge ports defined therein for discharging the protective coating from within the coating reservoir; a feed tube, provided on a top surface of the block, for feeding the protective coating into the coating reservoir; front and rear plates provided on front and rear surfaces of the block, respectively, the front and rear plates each having at least one cutout portion; a pair of supply tubes, provided on the front and rear plates, respectively, for supplying compressed air into gaps between the front plate and the front surface of the block and between the rear plate and the rear surface of the block; a pair of front and rear jet ports, defined between the nozzle plate and a lower portion of the front plate and between the nozzle plate and a lower portion of the rear plate, respectively, for emitting jets of the compressed air to spread the protective coating discharged from the discharge ports; and the directional control valve allowing supply of the compressed air to one of the pair of the supply tubes on the basis of a direction of movement of the application nozzle unit.

Because the compressed air is used for spreading the protective coating over the workpiece, the spread protective coating has no mark which would be otherwise left thereon if a roller, a bristle or the like were used. Thus, the protective coating has its clean surface.

Moreover, as the application nozzle unit applies the protective coating while moving reciprocally, the nozzle unit need not turn through 180 degrees. Because the nozzle unit need not change its orientation, the nozzle unit can more efficiently perform an applying operation.

Preferably, the front and rear plates are vertically movable relative to the block.

Desirably, the nozzle plate is provided on the block through an O ring.

Preferably, each discharge port is designed to have a diameter of 0.4 to 0.6 mm.

In a preferred form, the at least one cutout portion comprises a recessed portion for providing a flat stream of the compressed air.

In a further preferred form, the at least one cutout portion comprises a plurality of groove portions of V-shaped cross-sections.

### BRIEF DESCRIPTION OF DRAWINGS

FIG. 1 is a side elevation view of an application nozzle unit for applying a protective coating to protect a paint film, in accordance with the present invention;

FIG. 2 is a cross-sectional view taken along line 2-2 of FIG. 1;

FIG. 3 is a perspective view of a plate of the application nozzle unit;

FIG. 4 is a view of the plate as viewed in a direction of an arrow 4 of FIG. 3;

FIG. 5 is a bottom view of the application nozzle unit;

FIG. 6 is a perspective view of the application nozzle unit;

FIG. 7 is a view showing a step for providing a painted workpiece and the application nozzle unit;

FIG. 8 is a view showing a step for feeding the protective coating from the application nozzle unit to the workpiece;

FIG. 9A is a view showing a step for blowing compressed air against the protective coating on the workpiece to level the protective coating;

FIG. 9B and FIG. 9C are views showing operations of a directional control valve for allowing the compressed air to be supplied to the application nozzle unit;

FIG. 10A is a view showing an operation of the application nozzle unit in accordance with the present invention and FIG. 10B is a view showing an operation of an application nozzle unit in a comparative example;

FIG. 11 is a view showing an alternative to the plate shown in FIG. 4;

FIG. 12 is an arrangement of a conventional application nozzle unit; and

FIG. 13 is a view showing an operation of the application nozzle unit shown in FIG. 12.

### BEST MODE FOR CARRYING OUT THE INVENTION

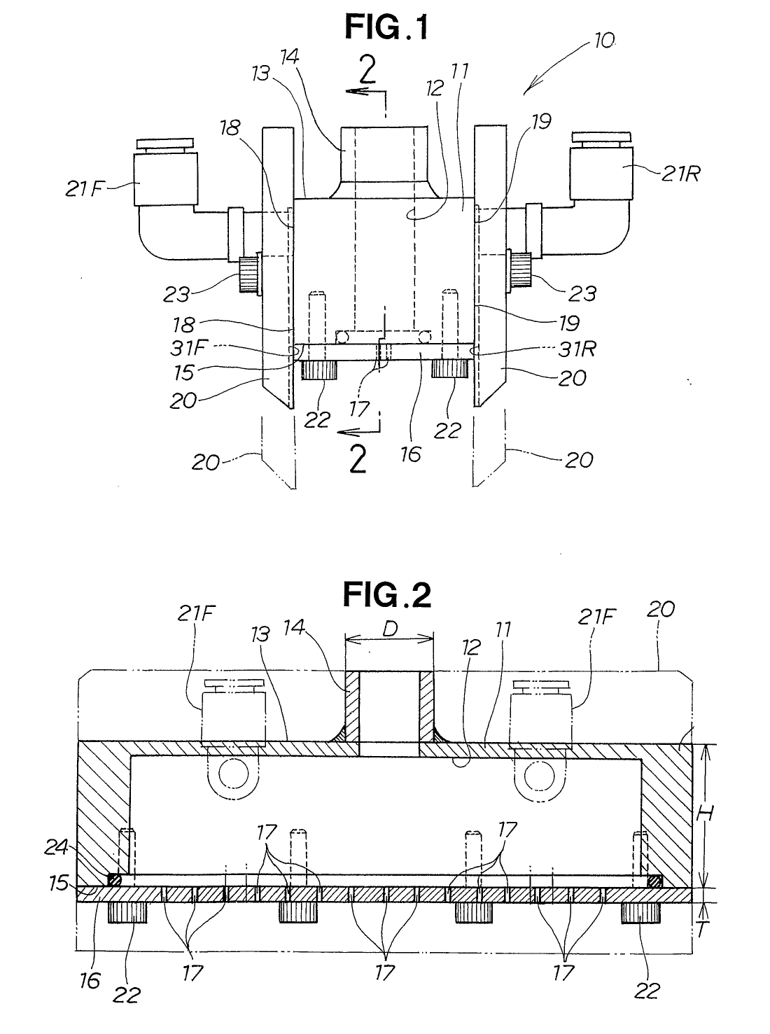

Referring to FIG. 1, an application nozzle unit 10 includes a block 11. The block 11 has a coating reservoir 12 defined therein for holding a protective coating. Provided on a top surface 13 of the block 11 is a feed pipe 14 for feeding a protective coating into the coating reservoir 12. Provided on a bottom surface 15 of the block 11 is a nozzle plate 16 defining a bottom of the coating reservoir 12. The nozzle plate 16 has a plurality of discharge ports 17 defined therein for discharging the protective coating from within the coating reservoir 12. Provided on front and rear surfaces 18, 19 of the block 11 are front and rear plates 20, 20. Provided on the front plate 20 are front supply tubes 21F, 21F for supplying compressed air into a gap defined between the front plate 20 and the front surface 18 of the block 11. Provided on the rear plate 20 are rear supply tubes 21F, 21R for supplying compressed air to a gap defined between the rear plate 20 and the rear surface 19 of the block 11.

The nozzle plate 16 is secured to the bottom surface 15 of the block 11 by fasteners 22, 22. The front and rear plates 20, 20 are secured to the front and rear surfaces 18, 19 of the block 11 by fasteners 23, 23. The fasteners 22, 23 are preferably bolts.

As shown in FIG. 2, the horizontally elongated coating reservoir 12 is defined in the horizontally elongated block 11. The coating reservoir 12 has a closed bottom defined by the nozzle plate 16. Sandwiched between the nozzle plate 16 and the block 11 is an O-ring 24 for providing a hermetic seal therebetween. The feed pipe 14 is positioned centrally in a right-and-left direction of the horizontally elongated coating reservoir 12.

In the illustrated embodiment, the block 11 has a height H of 30 mm. The nozzle plate 16 has a thickness t from 1 to 3 mm. The feed pipe 14 has an outer diameter D of 17 mm.

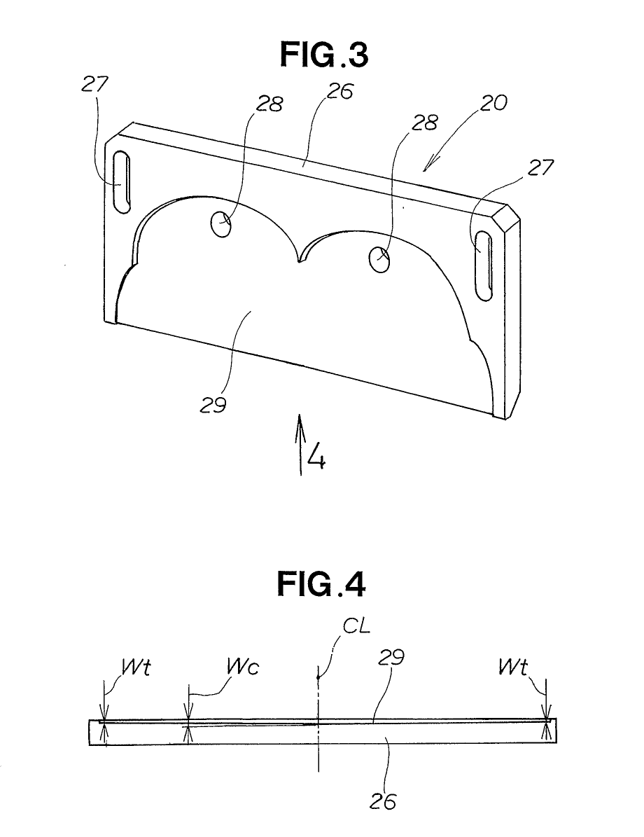

Discussion will be made as to structure of the plate 20 with reference to FIG. 3 and FIG. 4.

As shown in FIG. 3, the plate 20 is made of a rectangular plate 26. The rectangular plate 26 has right and left vertically-elongated holes 27, 27 defined in right and left end portions of the plate 26. The rectangular plate 26 has a pair of openings 28, 28 defined therein. The plate 26 also has a shallow recessed portion 29 formed at one side thereof for providing flattened streams of compressed air blown out of the openings 28, 28.

As shown in FIG. 4, the shallow recessed portion 29 has a depth increasing gradually towards a longitudinally center line CL of the recessed portion 29. Namely, the recessed portion 29 has opposite portions of depths Wt, Wt smaller than a depth Wc of a central portion of the recessed portion 29.

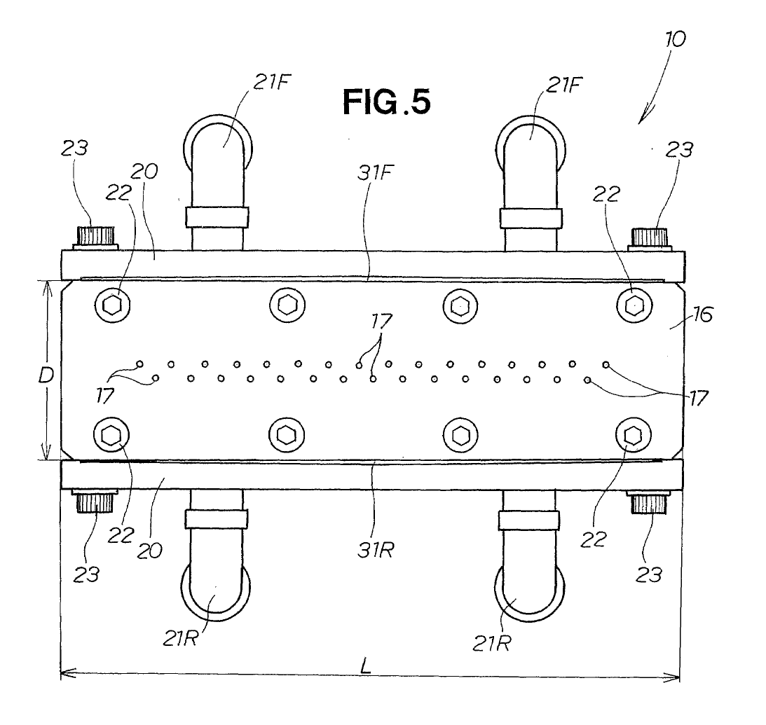

Discussion will be made as to a bottom of the application nozzle unit 10 with reference to FIG. 5.

As shown in FIG. 5, the horizontally-elongated nozzle plate 16 has a great number of the discharge ports 17 arranged in two rows. One of the two rows of the discharge ports 17 is horizontally displaced relative to the other row by one half of a pitch between adjacent discharge ports 17. The discharge ports 17 in the two rows are arranged in a staggered fashion.

Between the front plate 20 and a front long side of the horizontally-elongated nozzle plate 16, there is defined a front jet port 31F for emitting a jet of compressed air. Similarly, between the rear plate 20 and a rear long side of the horizontally-elongated nozzle plate 16, there is defined a rear jet port 31R for emitting a jet of compressed air.

In the illustrated embodiment, the nozzle plate 16 has a length L of 120 mm and a width D of 35 mm.

The number of the discharge ports 17 defined in the nozzle plate 16 is determined by a width of an area to be coated with the protective coating. For example, where such a width is 90 mm, fifteen discharge ports 17 each having a diameter from 0.4 to 0.6 mm are arranged in a row at pitches of 6 mm while fourteen discharge ports 17 each having a diameter from 0.4 to 0.6 mm are arranged in a row at pitches of 6 mm. Namely, a total of twenty nine discharge ports 17 is provided in a staggered fashion. Alternatively, thirty two discharge ports 17 each having a diameter from 0.4 to 0.6 mm may be arranged in a row at pitches of 3 mm while thirty one discharge ports 17 each having a diameter from 0.4 to 0.6 mm may be arranged in a row at pitches of 3 mm. In this case, a total of sixty three discharge ports 17 is provided in a staggered fashion. Alternatively, the nozzle plate 16 may have only one row of fifteen discharge ports 17 arranged at pitches of 6 mm.

Where a width of an area to be coated with a protective coating is 48 mm, eight discharge ports 17 each having a diameter from 0.4 to 0.6 mm are arranged in a row at pitches of 6 mm while seven discharge ports 17 each having a diameter from 0.4 to 0.6 mm are arranged in a row at pitches of 6 mm. A total of fifteen discharge ports 17 is arranged in a staggered fashion. Alternatively, sixteen discharge ports 17 each having a diameter from 0.4 to 0.6 mm may be arranged in a row at pitches of 3 mm while fifteen discharge ports 17 each having a diameter from 0.4 to 0.6 mm may be arranged in a row at pitches of 3 mm. In this case, a total of thirty one discharge ports 17 is arranged in a staggered fashion. Alternatively, the nozzle plate 16 may have only one row of eight discharge ports 17 arranged at pitches of 6 mm.

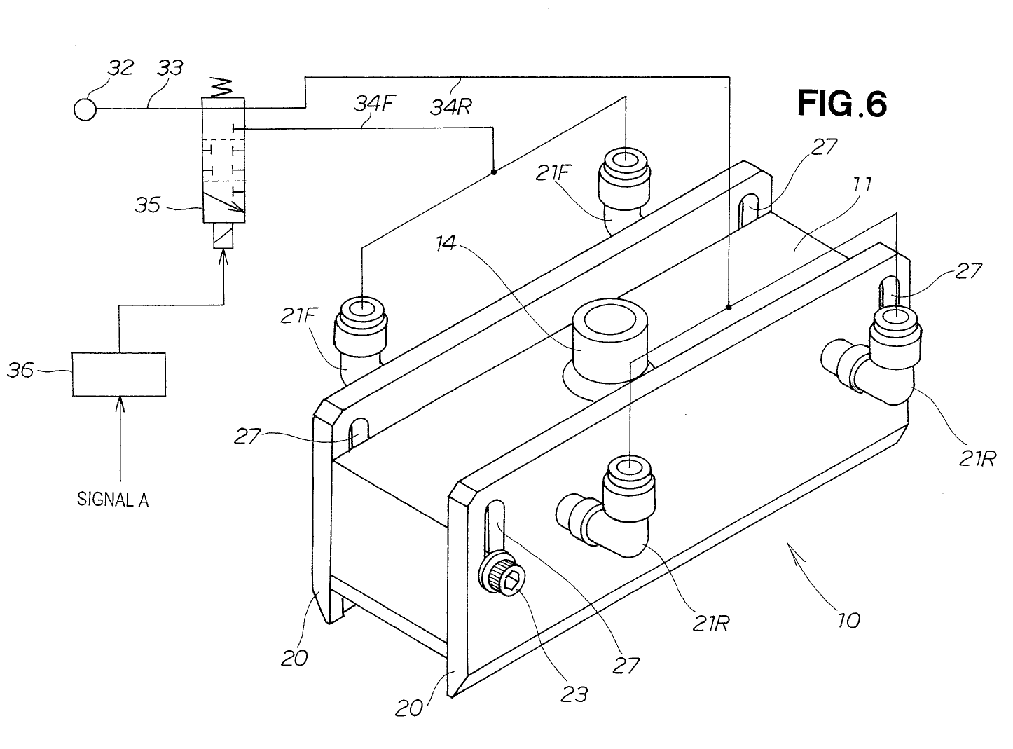

Reference is made to FIG. 6. The front and rear plates 20, 20 are disposed on front and rear sides of the block 11. By loosening the fasteners 23, 23, it becomes possible to move the plates 20, 20 vertically a distance equal to or less than a length of the elongated hole 27.

A main air tube 33 extending from a source 32 of compressed air has a distal end connected to a directional control valve 35 from which two air tubes (front and rear air tubes) 34F, 34R extend. The front air tube 34F is connected to the front supply tubes 21F, 21F. The rear air tube 34R is connected to the rear supply tubes 21R, 21R. The directional control valve 35 is operated by a valve control section 36. The valve control section 36 receives a signal A indicative of information on a direction of movement of the application nozzle unit 10.

Next, operation of the application nozzle unit 10 will be discussed.

As shown in FIG. 7, the application nozzle unit 10 is disposed facing toward a painted workpiece 37.

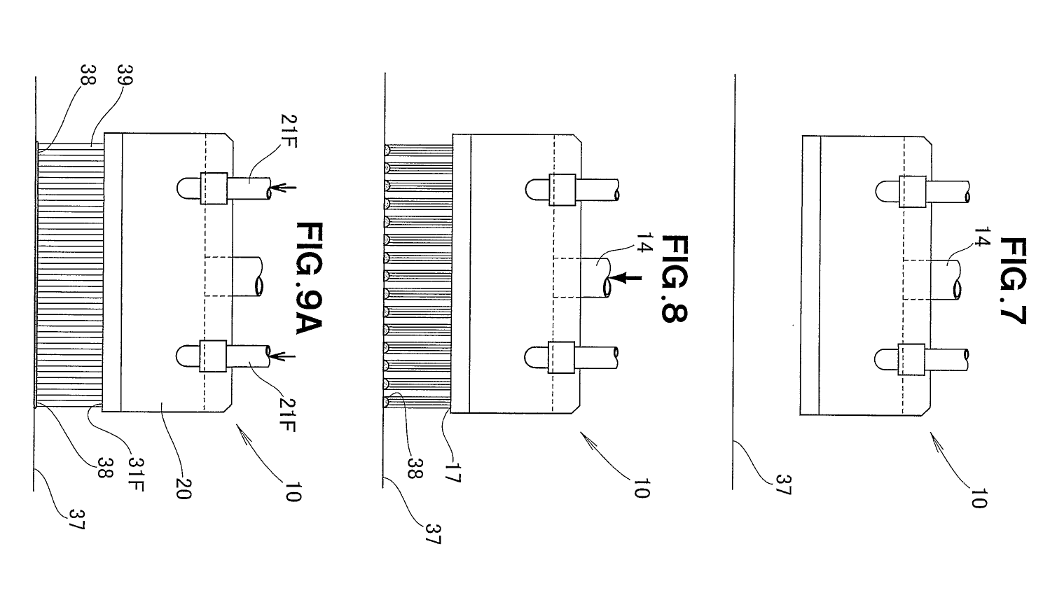

The operation of the application nozzle unit 10 starts from a step of feeding a protective coating 38 to the workpiece 37. More specifically, as shown in FIG. 8, the protective coating 38 is discharged out through the discharge ports 17 onto the workpiece 37. While discharging the protective coating 38, the application nozzle unit 10 moves in a direction directed down out of a plane of FIG. 8.

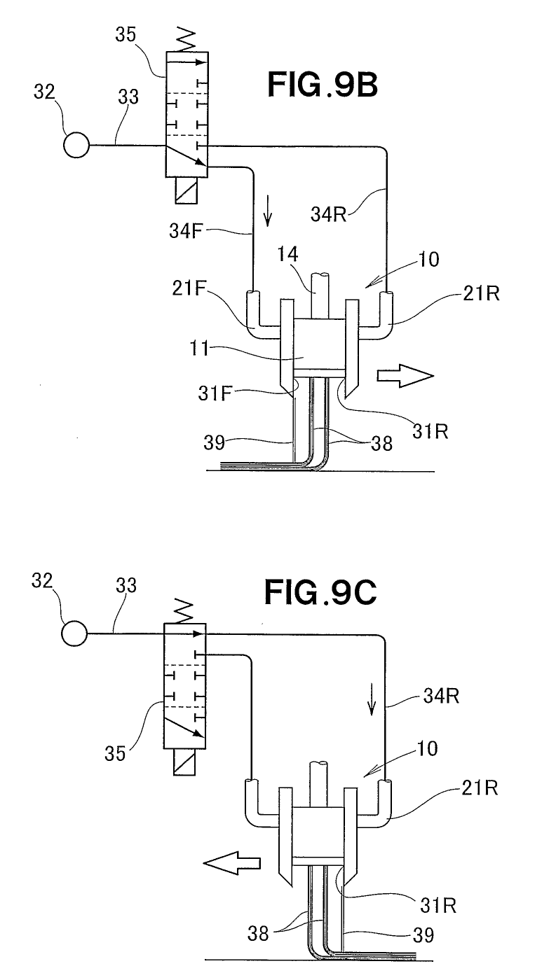

The operation of the application nozzle unit 10 proceeds to a step of leveling the protective coating 38 on the workpiece 37. More specifically, as shown in FIG. 9A, the protective coating 38 is spread under pressure of compressed air 39 jetting from the jet port 31F.

As shown in FIG. 9B, the application nozzle unit 10 includes the front and rear jet ports 31F, 31R located forwardly and rearwardly of the discharge ports 17 (FIG. 1), respectively. When the application nozzle unit 10 moves rearward (rightward of FIG. 9B), as shown by a profiled arrow of FIG. 9B, the directional control valve 35 is operated such that compressed air is supplied through the front air tube 34F to the front supply tubes 21F, 21F. Then, the compressed air, designated at 39, jets from the front jet port 31F.

When the application nozzle unit 10 moves forward (leftward of FIG. 9C), as shown by a profiled arrow of FIG. 9C, the directional control valve 35 is operated such that compressed air is supplied through the rear air tube 34R to the rear supply tubes 21R, 21R. Then the compressed air, denoted by reference numeral 39, jets from the rear jet port 31R.

Namely, while the application nozzle unit 10 moves to and fro (rightward and leftward in FIG. 9B or 9C), the directional control valve 35 is operated such that the compressed air jets from the corresponding one of the front jet port 31F and the rear jet port 31R. Because the application nozzle unit 10 moves reciprocally without having to make any turn, an applying operation can be more efficiently performed imposing a reduced burden on a robot.

In the illustrated embodiment, the protective coating 38, immediately after applied to the workpiece 37, is in the form of a wet film having a thickness of 120 μm to 200 μm, preferably, 160 μm.

Discussion will be made as to a case where a diameter of the discharge port 17 is set to be equal to or less than 1 mm, and a case where a diameter of the discharge port 17 is set to exceed 1 mm.

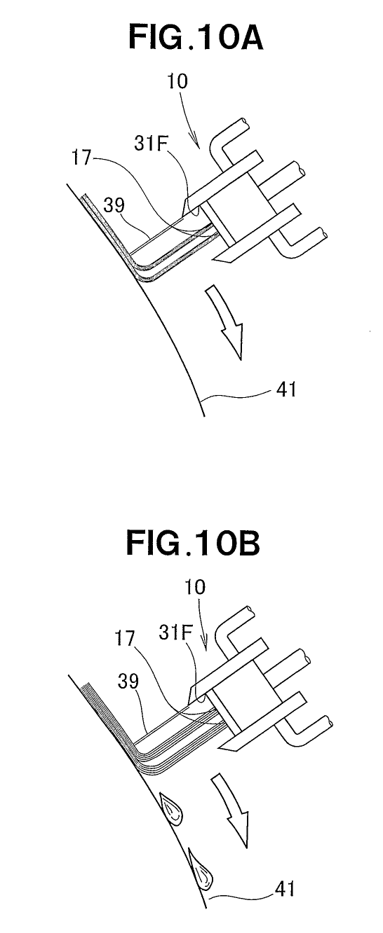

As shown in FIG. 10A, the discharge ports 17 each having a diameter of 1 mm or less, preferably, in the range of 0.4 to 0.6 mm, discharge jets of the protective coating to a steep surface 41 of a workpiece (not designated). As a result, the protective coating is put in the form of a thin line on the steep surface 41. This protective coating is rapidly spread over the surface 41 under pressure of compressed air 39 jetting from the front jet port 31F.

As shown in FIG. 10B, the discharge ports 17 each having a diameter exceeding 1 mm, discharge jets of the protective coating to a steep surface 41 of a workpiece (not designated). As a result, the protective coating is put in the form of a thick line on the surface 41. This protective coating can not be sufficiently spread over the surface 41 under pressure of compressed air 39 jetting from the front jet port 31F. In addition, parts of the protective coating descend in the form of drops along the surface 41.

Thus, it is effective to set the diameter of the discharge port 17 to be 1 mm or less, preferably, in the range of 0.4 to 0.6 mm.

The discharge ports 17 is not only circular but also square, rectangular or octagonal in shape. The discharge ports 17 are designed to be small in size on the basis of viscosity and thixotropy of the protective coating. The thixotropy means a property of varying in viscosity when the coating is subjected to a shearing force.

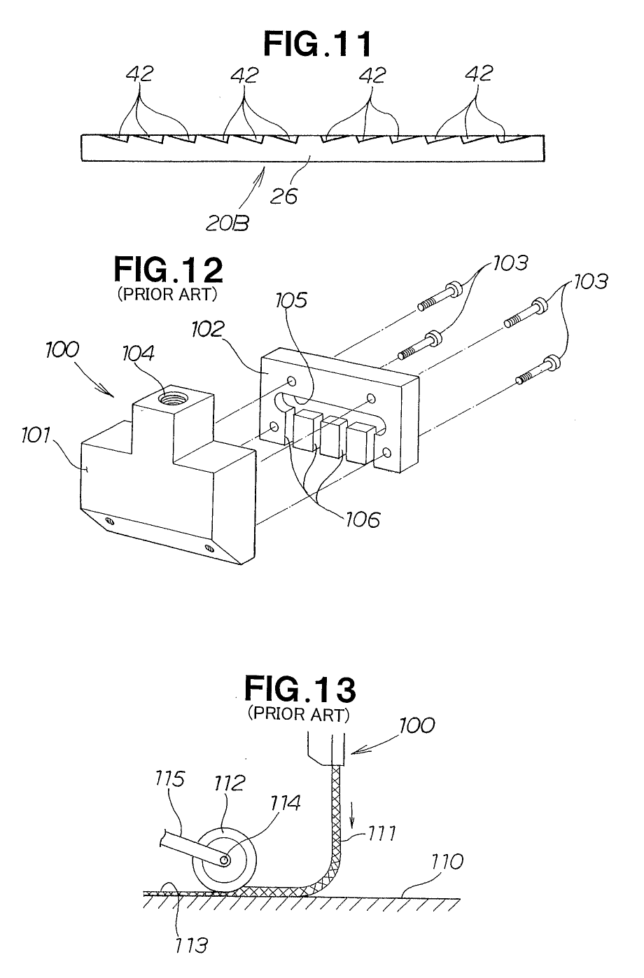

An alternative to the plate 20 shown in FIG. 4 will be described with reference to FIG. 11.

As shown in FIG. 11, a plate 20B is made of a rectangular plate 26 having on one side surface a plurality of groove portions 42 of V-shaped cross-sections, in place of the shallow recessed portion 29 shown in FIG. 4. The groove portions 42 have their individually set depths. Namely, the depth of the groove portion 42 is easier to set than that of the recessed portion 29.

Although the preferred embodiment of the present invention has been described as to protection of a paint film formed on a workpiece, the present invention is also applicable to protection of paint films formed on vehicle bodies, machines and the like.

### INDUSTRIAL APPLICABILITY

The application method and nozzle unit of the present invention are useful in applying a protective coating to a painted vehicle body.

1. A method for applying a protective coating to a painted workpiece, the method comprising the steps of:
feeding the protective coating from an application nozzle unit to the workpiece, the application nozzle unit having a plurality of discharge ports a front jet port located forwardly of the discharge ports, and a rear jet port located rearwardly of the discharge ports; and
radiating streams of compressed air at the fed protective coating to thereby uniformly spread the protective coating,
wherein the feeding step comprises discharging with the streams of compressed air the protective coating from the discharge ports of the application nozzle unit while moving the application nozzle unit to and fro, and the radiating step comprises jetting the streams of compressed air only from the front one of the jet ports of the application nozzle unit and located forwardly of the discharge ports during rearward movement of the application nozzle unit, and jetting the streams of compressed air only from a rear one of the jet ports of the application nozzle unit during forward movement of the application nozzle unit.

2-5. (canceled)

6. An application apparatus for applying a protective coating to a painted workpiece, the apparatus comprising:
a moveable application nozzle unit;
a directional control valve;
the application nozzle unit including:
a block having a coating reservoir defined therein for holding the protective coating;
a nozzle plate having a plurality of discharge ports defined therein for discharging the protective coating from within the coating reservoir;
a feed tube, provided on a top surface of the block, for feeding the protective coating into the coating reservoir;
front and rear plates provided on front and rear surfaces of the block, respectively, the front and rear plates each having at least one cutout portion;
a pair of supply tubes, provided on the front and rear plates, respectively, for supplying compressed air into gaps between the front plate and a front surface of the block and between the rear plate and a rear surface of the block; and
a pair of front and rear jet ports, defined between the nozzle plate and a lower portion of the front plate and between the nozzle plate and a lower portion of the rear plate, respectively, for emitting jets of the compressed air to spread the protective coating discharged from the discharge ports; and
the directional control valve allowing supply of the compressed air to one of the supply tubes on the basis of a direction of movement of the application nozzle unit,
wherein the at least one cutout portion comprises a plurality of groove portions of V-shaped cross-section.

7-9. (canceled)

10. The applying apparatus of claim 6, wherein the at least one cutout portion comprises a recessed portion for providing a flat stream of the compressed air.

11. (canceled)

12. the applying apparatus of claim 6, wherein the front and rear plates are vertically movable relative to the block.
